(19) United States
(12) Patent Application Publication
(10) Pub. No.: US 2008/0285618 A1
(43) Pub. Date: Nov. 20, 2008

(54) Infrared thermometer

(76) Inventor: Chean-Shui Chen, Taipei (TW)

Correspondence Address: Chean-Shui Chen, #33, Alley 16, Lane 313, Sec. 1, Shi An Street, Peitou Dist., Taipei, 112, TW

(21) Appl. No.: 11/798,344

(22) Filed: May 14, 2007

(51) Int. Cl. G01J 5/04; G01J 5/00

(52) U.S. Cl. 374/121; 374/208

(57) ABSTRACT

An infrared thermometer is disclosed in the present invention, wherein the elastic covering of the probe thereof can be driven to extend outwardly like a cone for measuring ear temperature, or driven to retract inwardly into the housing for measuring forehead temperature, so as to achieve the objective of switching modes between measuring ear/forehead temperature conveniently. In addition, the elastic covering provides enhanced tender feeling to the ear or forehead of the person to be measured in both modes. The upper seat and the lower seat of the housing can be pivotally rotated to different angles to meet demands that may arise during the operation of the infrared thermometer, such as during self-measurement or measurement of other people, so as to facilitate the use of the infrared thermometer.

### BACKGROUND OF THE INVENTION

1. Field of the Invention

The present invention relates to an infrared thermometer, and the elastic covering of the probe thereof can be driven back and held open outwardly like a cone for measuring ear temperature, or driven and turned inwardly into the housing for measuring forehead temperature, so as to achieve the objective of switching modes between measuring ear/forehead temperature conveniently. Besides, the upper seat and the lower seat of the housing can be adjusted to various angles to meet the demands that may arise during the operation of the infrared thermometer.

2. Description of the Related Art

As various viruses such as influenza, SARS, enterovirus and avian influenza occur in succession, the concept of managing one's own health is becoming more important. When monitoring body temperature has become an essential step for individual health management, infrared thermometers are not only used in hospitals or clinics, but also popularly implemented in everybody's daily life. Conventional infrared thermometers with the function of switching between modes for measuring ear/forehead temperature (as shown in FIG. 1 and FIG. 2) mainly comprise a supporting frame 81 mounted slidably on a housing 82. When the supporting frame 81 is pulled upwardly, a circular end surface 811 of the supporting frame 81 can become contact the forehead where the temperature to be taken and therefore facilitates the measurement. When the supporting frame 81 is pulled downwardly, a protruding probe 83 is revealed and can be inserted into the ear canal to measure body temperature otherwise. However, drawbacks have been found to exist in the above-mentioned structure:

1. The movable supporting frame 81 is exposed and thus is liable to be contaminated. This may consequently raise hygienic concerns when in use.

2. After a period of use, the supporting frame 81 could become loosened. Moreover, if the infrared thermometer is dropped accidentally, the pivotal connection between the two ends of the supporting frame 81 and the housing 82 could likely be damaged, and this results that the infrared thermometer becomes handicapped for not able to take forehead temperature any more.

3. Since the probe 83 and the supporting frame 81 are both made of hard materials, discomfort may be caused to a user either when the probe 83 is inserted into the ear canal of the user or when the circular end surface 811 of the supporting frame 81 is pressed against the user's forehead due to the hardness of the two components. Particularly, when it's a child's temperature to be taken, such discomfort could easily upset the child and make him to resist the measurement.

4. Since the angle of the housing 82 is not adjustable, such a conventional infrared thermometer can not be adapted for use in different situations.

Another conventional infrared thermometer 9 with the function of switching between modes for measuring ear/forehead temperatures is shown in FIG. 3, wherein a switching device (not shown in the figure) is operatable by adjusting a pivotally rotatable hemispherical cover 91 to achieve the switching between ear/forehead temperature measuring modes. However, it has been found to have following drawbacks:

1. The hemispherical cover 91 and the probe 92 are also made of hard materials, and similarly causes discomfort to the user during measurement as discussed previously.

2. Likewise, since the angle of the housing 90 is not adjustable, such a conventional infrared thermometer can not be adapted for use in different situations.

### SUMMARY OF THE INVENTION

disclosed in the invention.

One objective of the present invention is to provide an infrared thermometer, wherein the elastic covering of the probe thereof can be driven to extend outwardly into a cone shape for facilitating measuring ear temperature, while it can be alternatively driven to retract inwardly back to the housing for facilitating measuring forehead temperature, so as to permit a convenient switch between measuring ear/forehead temperature measuring mode.

Another objective of the present invention is to provide an infrared thermometer, wherein the upper seat and the lower seat of the housing thereof can be adjusted to different angles to meet the demands that may arise during the operation of the infrared thermometer.

Still another objective of the present invention is to provide an infrared thermometer which contacts the user to be measured with the elastic covering thereof that provides enhanced tender feeling.

Still another objective of the present invention is to provide an infrared thermometer, wherein the sensor is mostly wrapped by a elastic covering and is more hygienic.

For achieving the objectives mentioned above, the present invention provides an infrared thermometer, wherein the probe is driven by a sliding disposed on the housing for the elastic covering to be driven to extend outwardly like a cone for measuring ear temperature. The probe can also be driven to retract inwardly into the housing by the sliding for measuring forehead temperature, so as to achieve the objective of switching modes between measuring ear/forehead temperature conveniently. In addition, the elastic covering provides enhanced tender feeling to the person to be measured in both measuring modes. The upper seat and the lower seat of the housing can be pivotally rotated to different angles to meet the demands that may arise during the operation of the infrared thermometer. Thus, no matter for self-measurement or for taking others' temperatures, the disclosed subject matter can ensure a convenient use.

matter can ensure a convenient use.

For achieving the objectives mentioned above, the present invention further proposes a structure for the infrared thermometer, wherein when the upper seat and the lower seat of the housing are pivotally rotated to different angles, the probe can be driven to protrude out of the housing or draw back into the housing automatically.

The aforesaid structure and effects of the invention will become apparent in the following detailed description with reference to the accompanying drawings.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of a conventional infrared thermometer;

FIG. 2 is another perspective view of the conventional infrared thermometer in another state of use;

FIG. 3 is a perspective view of another conventional infrared thermometer;

FIG. 4 is a partly exploded view of a preferred embodiment of the present invention;

FIG. 5 is a perspective view of the preferred embodiment shown in FIG. 4;

FIG. 6 is a cross-sectional enlarged view of the preferred embodiment shown in FIG. 4 without a sensor installed on the probe and without a linking block connected;

FIG. 7 is a lateral enlarged view of the preferred embodiment shown in FIG. 4;

FIG. 8 is an assembled cross-sectional enlarged view of the preferred embodiment shown in FIG. 4;

FIG. 9 is a lateral enlarged view of the preferred embodiment shown in FIG. 4 in another state of use;

FIG. 10 is an assembled cross-sectional enlarged view of the preferred embodiment shown in FIG. 4 in another state of use;

FIG. 11 is a partly exploded enlarged view of the preferred embodiment shown in FIG. 4 at another viewing angle;

FIG. 12 is a partly exploded enlarged view of the preferred embodiment shown in FIG. 4 at another viewing angle;

FIG. 13 is a lateral enlarged view of the preferred embodiment shown in FIG. 4 at a pivotally rotated angle;

FIG. 14 is an assembled cross-sectional enlarged view of the referred embodiment shown in FIG. 4 at a pivotally rotated angle;

FIG. 15 is a lateral enlarged view of the preferred embodiment shown in FIG. 4 at a pivotally rotated angle in another state of use;

FIG. 16 is an assembled cross-sectional enlarged view of the referred embodiment shown in FIG. 4 at a pivotally rotated angle in another state of use;

FIG. 17 is an assembled cross-sectional enlarged view of another referred embodiment of the present invention; and

FIG. 18 is an assembled cross-sectional view of the referred embodiment shown in FIG. 17 at a pivotally rotated angle.

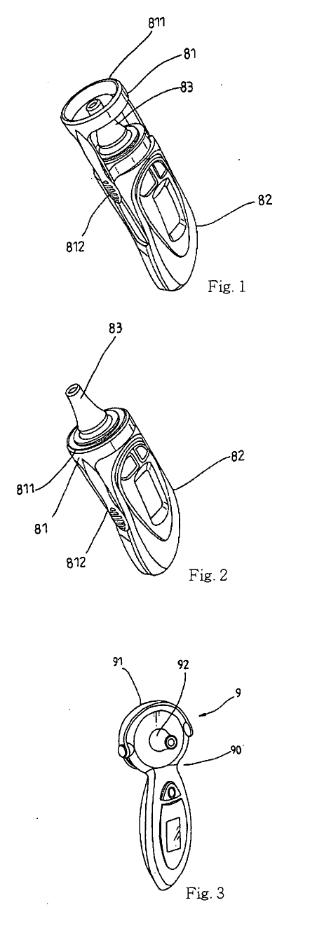

### DETAILED DESCRIPTION OF THE PREFERRED EMBODIMENT

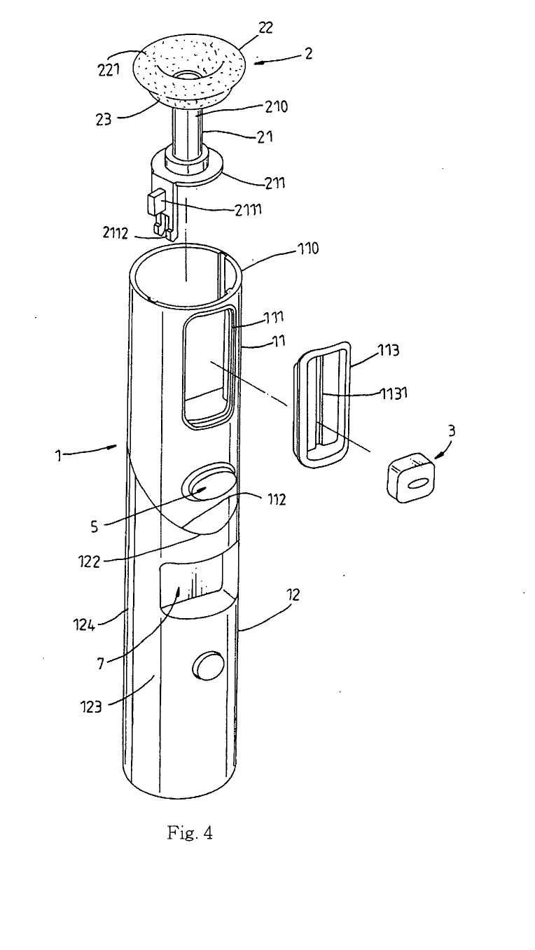

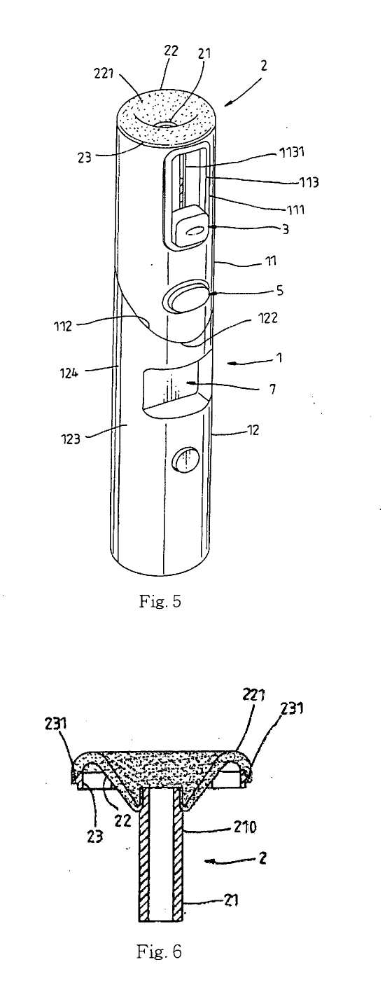

As shown in FIG. 4 to FIG. 10, an infrared thermometer according to one preferred embodiment of the present invention comprises a housing 1, a probe 2, a sensor 20 or other sensing components, a sliding 3, a switch 4 for switching between measuring ear/forehead temperature (referring to FIG. 8), a measuring button 5, a control circuit assembly 6, a LCD and the outer locating part 23. A sensor 20 (referring to FIG. 8) is disposed within an upper part 210 of the inner locating part 21, and a linking block 211 is disposed there below. A protruding part 2111 is disposed on another end of the linking block 211 and can slide back and forth along one side of the housing 1. A lower end 231 (referring to FIG. 6 and FIG. 8) of the outer locating part 23 is for connecting with an upper edge 110 of the housing 1.

The sliding 3 is disposed in a sliding groove 111 of the housing 1 and has a wedging groove 31 for connecting with a wedging sleeve of a protruding part 2111 at a lateral side of the linking block 211 of the probe 2. The sliding 3 can drive the probe 2 to slide back and forth in the sliding groove 111 on the housing 1, thereby forming a sliding mechanism.

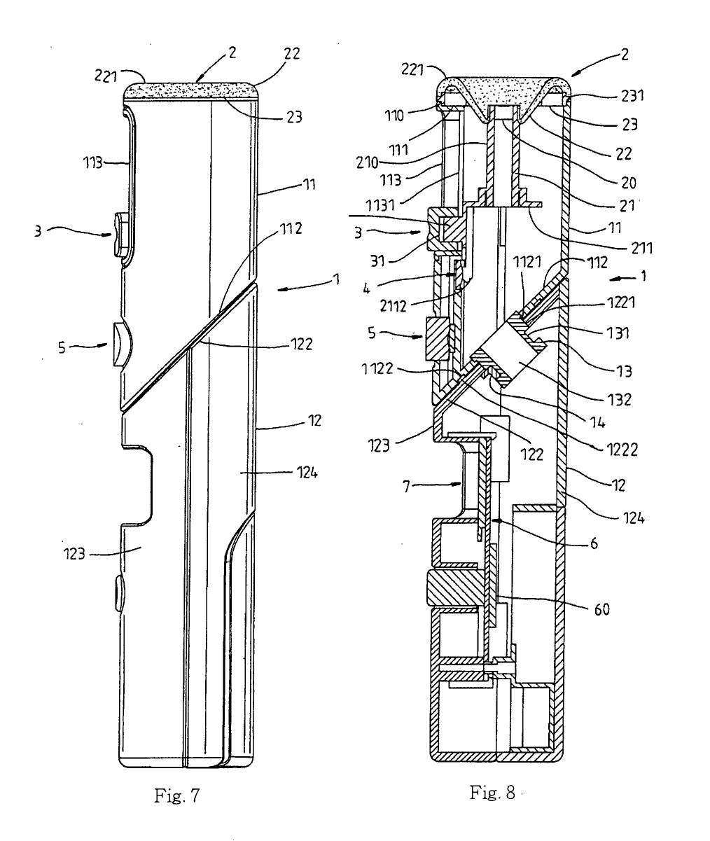

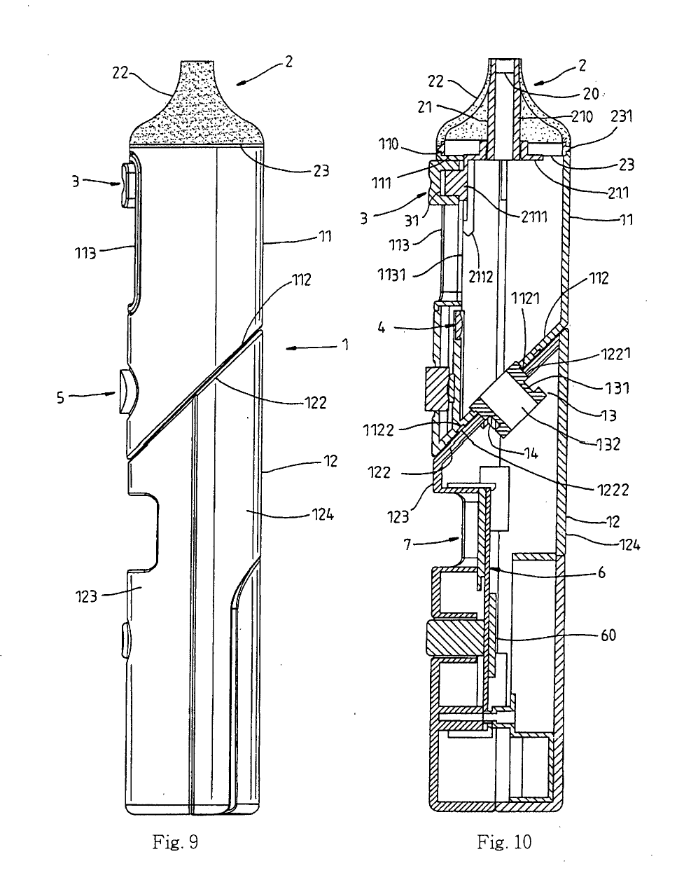

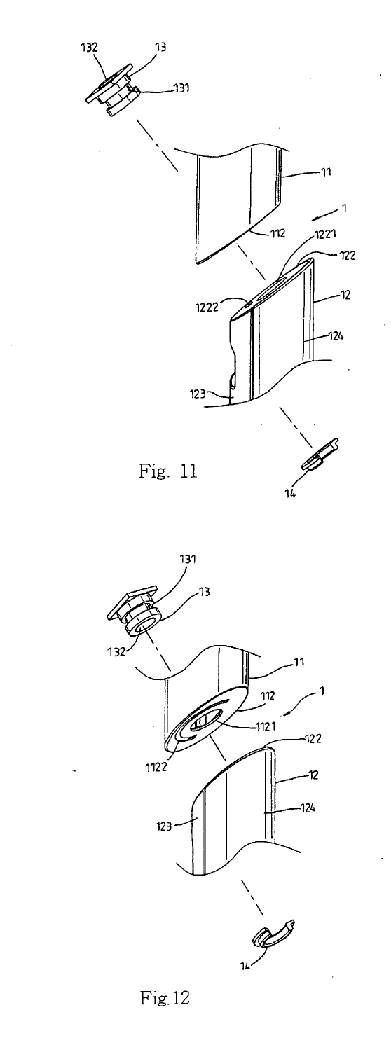

Thereby, when the sliding 3 moves upwardly along the sliding groove 111 on the housing 1, the inner locating part 21 of the probe 2 is driven to move upwardly, which allows the elastic covering 22 to be driven to extend outwardly like a cone, and thus the probe 2 appears in a protruding state (referring to FIG. 9 and FIG. 10) that can be inserted into the ear canal to measure ear temperature. Whereas, when the sliding 3 moves downwardly, the inner locating part 21 of the probe 2 is driven to move downwardly to retract the elastic covering 22 inwardly into the housing 1, thereby allowing the probe 2 to appear retracted into the housing 1. The elastic covering 22 forms a flexible contacting part (referring to FIG. 7 and FIG. 8), which facilitates taking forehead temperature. When the sliding 3 moves downwardly, a lateral end 2112 of the linking block 211 of the inner locating part 21 of the probe 2 presses against the switch 4 of the housing 1, so that the mode for measuring forehead temperature is switched on; on the contrary, when the sliding 3 moves upwardly and away from the switch 4, the mode for measuring ear temperature is switched on.

Furthermore, a locating frame 113 can be wedged in the sliding groove 111 on the housing 1 and has a groove hole 1131 for the protruding part 2111 of the linking block 211 of the probe 2 to be disposed through, so as to allow the locating frame 113 to slide back and forth along the sliding groove 111.

In addition, when putting the present invention into practice, the probe 2, the inner locating part 21, the elastic covering 22 and the outer locating part 23 can be made by double injection molding. The elastic covering 22 of the probe 2 is connected between the inner locating part 21 and the outer locating part 23.

Furthermore, the rigid outer locating part 23 of the probe 2 is of a ring shape. The upper part 210 of the rigid inner locating part 21 is of a sleeve shape and the linking block 211 below can be connected to the upper part 210 of the rigid inner locating part 21 by a locking member (not shown in the figure) or by other methods.

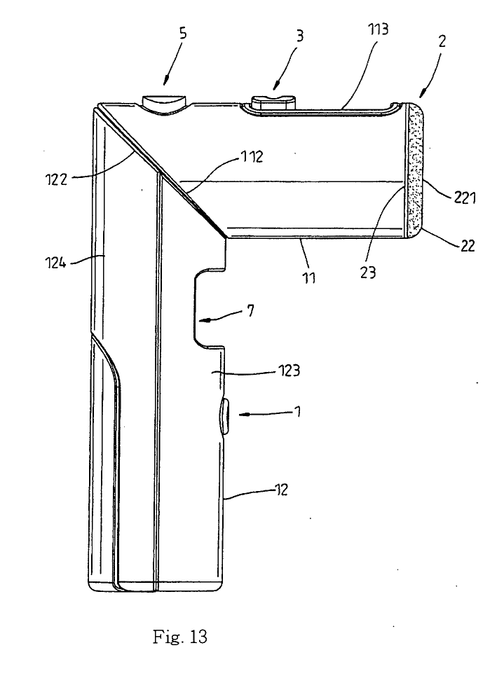

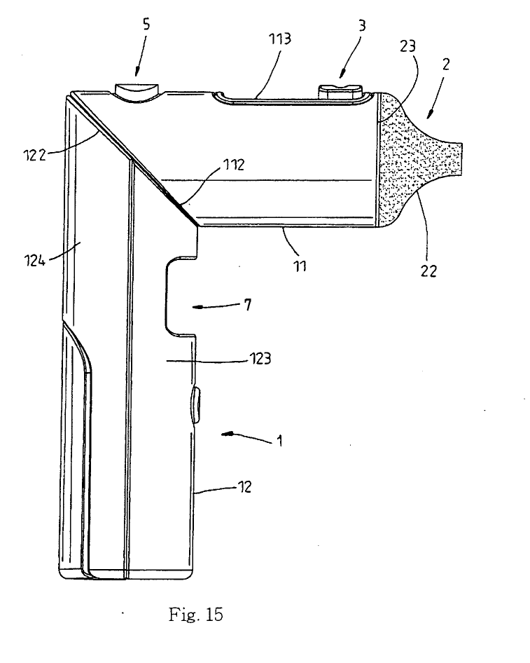

Please refer to FIG. 8 and FIG. 11 to FIG. 12. An upper seat 11 and a lower seat 12 are pivotally connected to form the housing 1 of the present invention. The upper seat 11 has a bottom face 112 tilting at a proper angle. The bottom face 112 has a pivotal hole 1121. The upper end face 122 of the lower seat 12 is also tilted at a proper angle and has a pivotal hole 1221 that can be pivotally connected by a pivotal shaft 13 and be wedged in the locating groove 131 of the pivotal shaft 13 by a locating member such as a C-shape retainer 14, so as to allow the upper seat 11 to be pivotally connected to the lower seat 12 and become pivotally rotatable. By the distinct pivotal rotatability of the upper seat 11 and the lower seat 12, various demands that may arise during the operation of the infrared thermometer can be satisfied (as shown from FIG. 13 to FIG. 16). Thus, no matter for self-measurement or for taking others' temperatures, the disclosed subject matter can ensure a convenient use.

In addition, a guiding groove 1122 and a locating post 1222 are disposed respectively on the bottom face 112 of the upper seat 11 and on the upper face 122 of the lower seat 12 of the housing 1, so as to limit the angle required by the pivotal rotation between the upper seat 11 and the lower seat 12.

Moreover, the sliding groove 111 of the housing 1 is disposed on the upper seat 11 while the upper seat 11 is further provided with the above-mentioned switch 4 and the measuring button 5. The lower seat 12 is provided with a LCD 7 and a control circuit assembly 6, wherein the LCD 7 displays the value of temperature as obtained by the sensor 20 of the probe 2. A battery 60 can be disposed in the lower seat 12 for supplying power for the operation of the infrared thermometer. It is simple to press down the measuring button 5 to begin taking temperature.

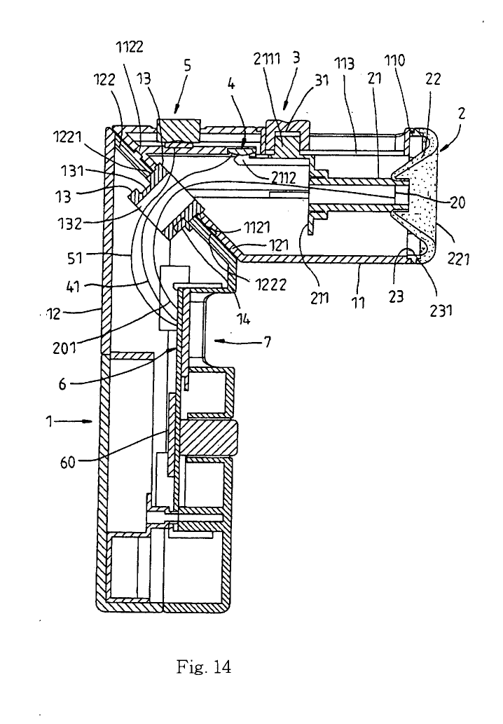

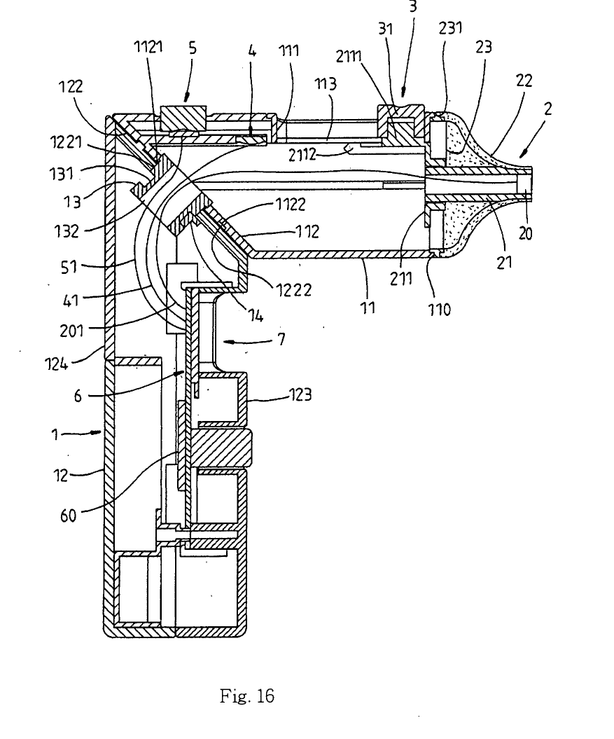

Furthermore, please refer to FIG. 14 and FIG. 16. The pivotal shaft 13 pivotally disposed in the upper seat 11 and the lower seat 12 has a pivotal hole 132 for a conducting wire 201 of the sensor 20, a conducting wire 41 connecting the switch 4 and a conducting wire 51 connecting the measuring button 5 to pass through and be connected with the control circuit assembly 6 of the lower seat 12 at the other ends of each conducting wire 201, 41 and 51.

Moreover, the lower seat 12 can be composed of two housings 123 and 124.

To sum up, the preferred embodiment of the present invention has the following effects:

1. The probe 2 can be driven by the sliding 3 disposed on the housing 1, and the elastic covering 22 thereof can be driven and extend outwardly like a cone for measuring ear temperature. The probe 2 can also be driven by the sliding 3 to retract the elastic covering 22 inwardly into the housing 1 and allow the elastic covering 22 to form a flexible contacting part 221 for measuring forehead temperature, so as to achieve the objective of conveniently switching modes between measuring ear/forehead temperature. The elastic covering 22 provides enhanced tender feeling to the person to be measured for temperature.

2. The upper seat 11 and the lower seat 12 of the housing 1 can be pivotally rotated to different angles to meet the demands that may arise during the operation of the infrared thermometer. Thus, no matter for self-measurement or for taking others' temperatures, the disclosed subject matter can ensure a convenient use.

3. The sensor 20 and the sliding mechanism are mostly wrapped by the elastic covering 22, and thus are more hygienic.

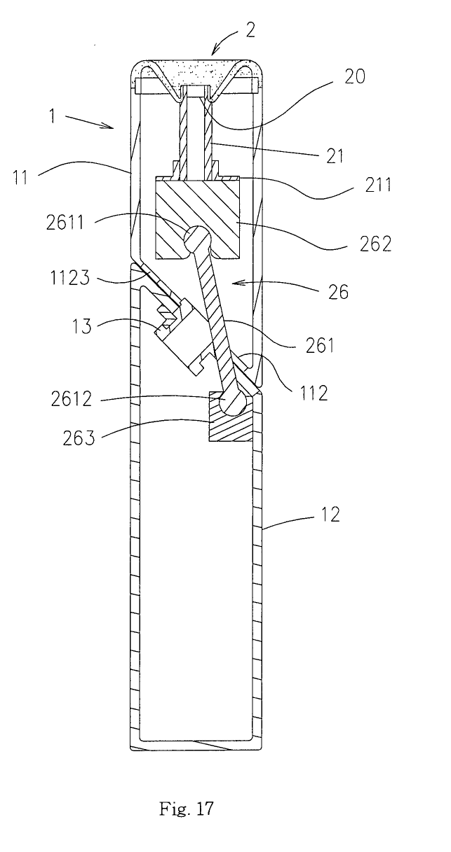

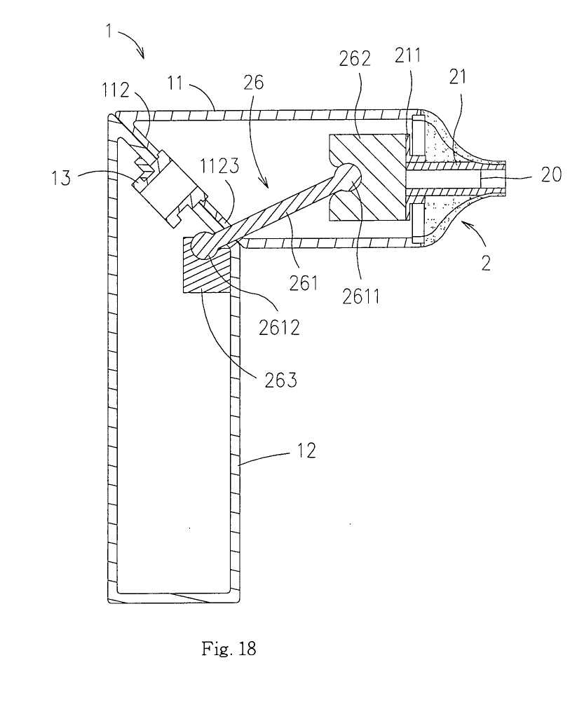

Please refer to FIG. 17 and FIG. 18. An infrared thermometer according to another preferred embodiment of the present invention comprises a housing 1, a probe 2, a sensor 20 or other sensing components, a measuring button, a control circuit assembly, a LCD and so on (not shown), which has the characteristics as discussed below.

The housing 1 is composed of an upper seat 11 and a lower seat 12 pivotally connected, and the upper seat 11 and the lower seat 12 can be pivotally rotated by the pivotal shaft 13. The housing 1 has a driving mechanism 26 comprising a driving shaft 261 provided with an upper connecting part 2611 and a lower connecting part 2612. An upper connecting block 262 is disposed on the bottom of a linking block 211 of the upper seat 11 and pivotally connected to the upper connecting part 2611. A lower connecting block 263 is disposed on the lower seat 12 and pivotally connected to the lower connecting part 2612 to form a driving mechanism.

The upper seat 11 has a bottom face 112 tilting at a proper angle. The bottom face 112 has a through groove 1123 for the driving shaft 261 to pass through to locate the driving shaft. The through groove 1123 surrounds the pivotal shaft 13 in an arc shape. Referring to FIG. 17, it should be noted that the driving shaft 261 is rotated to the front of the pivotal shaft 13 but not interfering with the pivotal shaft 13. Moreover, the shapes of the upper connecting part 2611, the lower connecting part 2612, the upper connecting block 262, and the lower connecting block 263 are decided according to actual needs. As shown in the figure, the spherical upper connecting part 2611 and the lower connecting part 2612 are just a preferred embodiment for providing pivotal rotation capable of moving toward any angles.

In other words, when the upper seat 11 and the lower seat 12 are turned relative to each other to the desired angle as shown in FIG. 18, the driving shaft 261 rotates around the pivotal shaft 13. The upper connecting part 2611 pivotally rotates about the upper connecting block 262, and the lower connecting part 2612 pivotally rotates about the lower connecting block 263, while the upper connecting block 262 is connected to the linking block 211, and the linking block 211 is connected to the sensor 20, thus the sensor 20 is driven to protrude out of the housing 1 automatically. When the upper seat 11 and the lower seat 12 are as shown in FIG. 17, the sensor 20 can be retracted into the housing 1 automatically.

A driving mechanism 26 is disposed in the preferred embodiment as shown in FIG. 17 and FIG. 18, wherein the sensor 20 is driven to protrude out of the housing 1 or retract into the housing 1 automatically according to the variation of the angle between the upper seat 11 and the lower seat 12 of the housing 1. Thus, the structure is simple and the operation of switching between modes for measuring ear/forehead temperature is made easier and more convenient.

While the present invention has been described in combination with what is considered the most practical and preferred embodiment, it is understood that this invention is not limited to the disclosed embodiments but is intended to cover various arrangements included within the spirit and scope of the broadest interpretation and equivalent arrangements in regard to the invention.

I claim:

1. An infrared thermometer, comprising a housing, a probe, a sensor, a sliding mechanism, a switch for switching between measuring ear/forehead temperature, a measuring button, a control circuit assembly and a LCD, and characterized by:
the probe having an elastic covering provided with the sensor, and the elastic covering being driven by the sliding mechanism slidably disposed on the housing.

2. The infrared thermometer as claimed in claim 1, wherein the probe further comprises a rigid inner locating part for connecting to an inner side of the elastic covering.

3. The infrared thermometer as claimed in claim 2, wherein the probe further comprises a rigid outer locating part for connecting to an outer side of the elastic covering, and a lower end of the outer locating part is connected to an upper end edge of the housing.

4. The infrared thermometer as claimed in claim 2, wherein a linking block is connected to the bottom of the inner locating part of the probe, and the linking block slides along with the probe, thereby pressing the switch for switching between measuring ear/forehead temperature that is disposed on the housing.

5. An infrared thermometer, comprising a housing, a probe, a sensor, a measuring button, a control circuit assembly and a LCD, and characterized by:
the housing being composed of an upper seat and a lower seat pivotally connected, wherein the upper seat has a bottom face tilting at a proper angle, and the bottom face has a pivotal hole, the upper face of the lower seat is also tilted at a proper angle and has a pivotal hole that can be pivotally connected by a pivotal shaft, so as to allow the upper seat to pivotally connect to the lower seat and become pivotally rotatable.

6. The infrared thermometer as claimed in claim 5, wherein a guiding groove and a locating post are disposed respectively on the bottom face of the upper seat and on the upper face of the lower seat of the housing, so as to limit the angle required by the pivotal rotation of the upper seat and the lower seat.

7. An infrared thermometer, comprising a housing, a probe, a sensor, a measuring button, a control circuit assembly and a LCD, and characterized by:
the housing being composed of an upper seat pivotally connected to a lower seat, wherein the housing has a driving mechanism comprising a driving shaft provided with an upper connecting part and a lower connecting part wherein:
an upper connecting block is disposed on the upper seat and connected to the probe, the upper connecting block is pivotally connected to the upper connecting part; and
a lower connecting block is disposed on the lower seat and pivotally connected to the lower connecting part so as to form a driving mechanism.

8. The infrared thermometer as claimed in claim 7, wherein the upper seat has a bottom face tilting at a proper angle, and the bottom face has a through groove for the driving shaft to pass through, so as to allow the driving shaft to be located.
